(19) United States
(12) Patent Application Publication
(10) Pub. No.: US 2025/0296681 A1
(43) Pub. Date: Sep. 25, 2025

(54) CONTROL SYSTEM, MOVING OBJECT, AND INFORMATION PROCESSING METHOD OF CONTROL SYSTEM

(71) Applicant: HONDA MOTOR CO., LTD., Tokyo (JP)

(72) Inventor: Hisao Haga, Wako-shi (JP)

(21) Appl. No.: 19/079,708

(22) Filed: Mar. 14, 2025

(30) Foreign Application Priority Data
Mar. 21, 2024 (JP) 2024-045019

(51) Int. Cl. B64C 27/68; B64C 29/00; H04L 12/40

(52) U.S. Cl. CPC B64C 27/68; B64C 29/00; H04L 12/40052; H04L 2012/40215; H04L 2012/4028

(57) ABSTRACT

A management controller includes a generating unit for generating a data frame, and a transmitting unit for transmitting the data frame. A junction box controller includes a receiving unit for receiving the data frame, a determining unit for determining commands for a plurality of devices, respectively, based on information written to the data frame, and a control unit for controlling the devices based on the commands determined by the determining unit.

### CROSS-REFERENCE TO RELATED APPLICATIONS

This application is based upon and claims the benefit of priority from Japanese Patent Application No. 2024-045019 filed on Mar. 21, 2024, the contents of which are incorporated herein by reference.

### BACKGROUND OF THE INVENTION

### Field of the Invention

The present disclosure relates to a control system, a moving object, and an information processing method of a control system.

### Description of the Related Art

JP 2023-144221 A discloses a system for transmitting and receiving data between a plurality of electronic control units via control area network communication.

### SUMMARY OF THE INVENTION

There has been a demand for a more satisfactory control system, a more satisfactory moving object, and a more satisfactory information processing method of a control system.

The present invention has the object of solving the aforementioned problem.

According to a first aspect of the present disclosure, there is provided a control system in which signals are transmitted and received between a plurality of control devices via serial communication, wherein a first control device of the plurality of control devices includes: a generating unit configured to generate a data frame including a plurality of sub-data fields; and a transmitting unit configured to transmit the data frame generated by the generating unit, and a second control device of the plurality of control devices includes: a receiving unit configured to receive the data frame transmitted from the first control device; a determining unit configured to determine commands for a plurality of devices, respectively, based on information written to the sub-data fields of the data frame received by the receiving unit; and a control unit configured to control the devices based on the commands determined by the determining unit, and wherein the generating unit writes status information, which is information indicating a status selected from a plurality of statuses, to the sub-data field allocated in advance to the status information, and the determining unit determines the commands for the respective devices based on the data frame received by the receiving unit.

According to a second aspect of the present disclosure, there is provided a moving object comprising the control system according to the first aspect.

According to a third aspect of the present disclosure, there is provided an information processing method of a control system in which signals are transmitted and received between a plurality of control devices via serial communication, wherein a first control device of the plurality of control devices executes: a generating step in which a generating unit generates a data frame including a plurality of sub-data fields; and a transmitting step in which a transmitting unit transmits the data frame generated by the generating unit, and a second control device of the plurality of control devices executes: a receiving step in which a receiving unit receives the data frame transmitted from the first control device; a determining step in which a determining unit determines commands for a plurality of devices, respectively, based on information written to the sub-data fields of the data frame received by the receiving unit; and a control step in which a control unit controls the devices based on the commands determined by the determining unit, and wherein, in the generating step, status information, which is information indicating a status selected from a plurality of statuses, is written to the sub-data field allocated in advance to the status information, and in the determining step, the determining unit determines the commands for the respective devices based on the data frame received by the receiving unit.

According to the present disclosure, it is possible to provide a more satisfactory control system, a more satisfactory moving object, and a more satisfactory information processing method of a control system.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object according to an embodiment of the present invention;

FIG. 2 is a schematic diagram showing a configuration of a power supply system according to the embodiment;

FIG. 3 is a schematic diagram showing a configuration of a control system according to the embodiment;

FIG. 4 shows control block diagrams of a management controller and a junction box controller according to the embodiment;

FIG. 5 is a diagram showing a configuration of a data field according to the embodiment;

FIG. 6 is a diagram showing an example of allocation of signals to statuses;

FIG. 7 shows control block diagrams of a management controller and a junction box controller according to a comparative example;

FIG. 8 is a flowchart of a data frame transmission process according to the embodiment; and

FIG. 9 is a flowchart of a device control process according to the embodiment.

### DETAILED DESCRIPTION OF THE INVENTION

In an electric vertical take-off and landing aircraft (eVTOL aircraft), rotors are driven by electric motors. Vertical thrust and horizontal thrust are generated by the rotors. The eVTOL aircraft is a hybrid aircraft. The eVTOL aircraft includes a generator and a battery as power sources of the electric motor. Electric power generated by the generator is supplied to each electric motor. In a case where the electric power generated by the generator is insufficient with respect to the electric power required by the electric motor, electric power stored in the battery is supplied to the electric motor.

A power supply system for supplying electric power of the generator to the electric motors includes a plurality of contactors. Each contactor is controlled by a controller (a lower-level controller), but the command for each contactor is determined by another controller (an upper-level controller).

The upper-level controller and the lower-level controller transmit and receive signals via control area network communication. In the control area network communication, serial communication is performed. The upper-level controller generates, for each contactor, a data frame including command information for the contactor, and transmits the generated data frame to the bus. Therefore, the amount of traffic on the bus may increase and the communication speed may decrease.

The control system of the present disclosure can reduce the number of data frames transmitted and received between controllers to reduce the amount of traffic on the bus and suppress a decrease in the communication speed.

### Embodiment

### [Configuration of Moving Object]

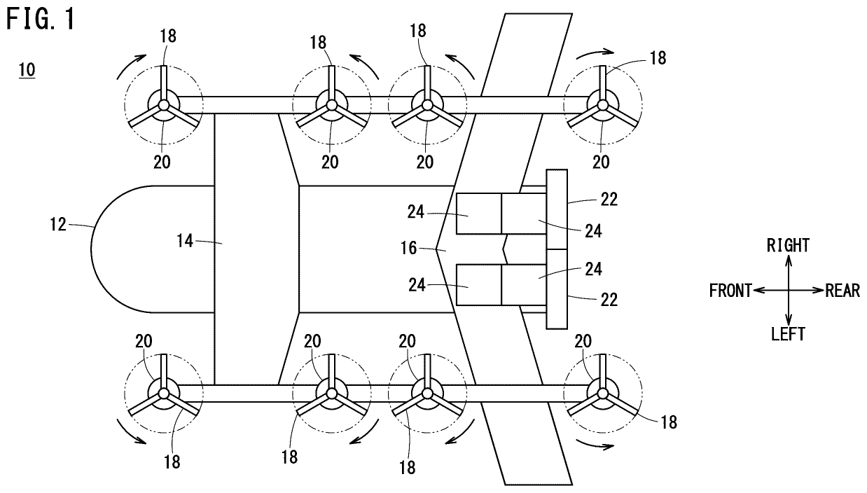

FIG. 1 is a schematic diagram of a moving object 10 according to an embodiment of the present invention. The moving object 10 of the embodiment is an electric vertical take-off and landing aircraft (eVTOL aircraft). The moving object 10 includes a fuselage 12. The fuselage 12 is provided with a cockpit, a cabin, and the like. A pilot rides in the cockpit and controls the moving object 10. Passengers and the like ride in the cabin. The moving object 10 may be automatically controlled.

The moving object 10 includes a front wing 14 and a rear wing 16. In a case where the moving object 10 moves forward, lift is generated in each of the front wing 14 and the rear wing 16.

The moving object 10 includes eight VTOL rotors 18 and two cruise rotors 22. One VTOL electric motor 20 is provided for one VTOL rotor 18. Two cruise electric motors 24 are provided for one cruise rotor 22.

### [Configuration of Power Supply System]

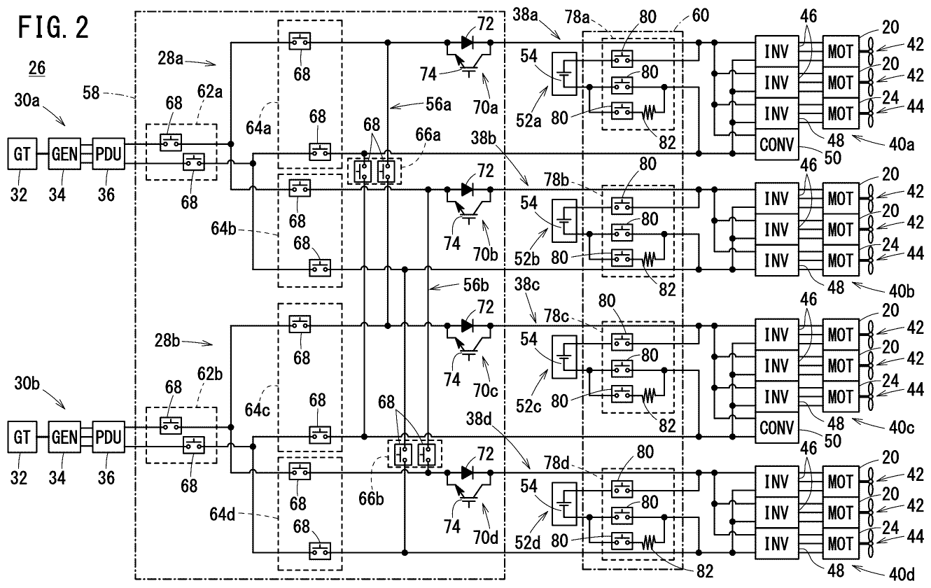

FIG. 2 is a schematic diagram showing a configuration of a power supply system 26 according to the embodiment. The power supply system 26 includes two power supply subsystems, that is, a first power supply subsystem 28a and a second power supply subsystem 28b. The power supply system 26 includes a first main power source device 30a as a main power source of the first power supply subsystem 28a. The power supply system 26 includes a second main power source device 30b as a main power source of the second power supply subsystem 28b.

Each of the first main power source device 30a and the second main power source device 30b includes a gas turbine 32, a generator 34, and a power drive unit (hereinafter, referred to as PDU) 36. The gas turbine 32 drives the generator 34. As a result, the generator 34 generates electric power. The PDU 36 converts the AC power generated by the generator 34 into DC power, and outputs the DC power. In a case where the gas turbine 32 is started, the PDU 36 converts the DC power input to the PDU 36 into AC power, and outputs the AC power to the generator 34. The generator 34 is operated by the AC power, and the generator 34 drives the gas turbine 32.

The first main power source device 30a and the second main power source device 30b may each include various sensors such as a voltage sensor and a current sensor, and elements such as a fuse, a relay, a breaker, a diode, a transistor, a resistor, a coil, and a capacitor.

The power supply system 26 includes a first power supply circuit 38a, a second power supply circuit 38b, a third power supply circuit 38c, and a fourth power supply circuit 38d.

The first power supply circuit 38a supplies, to a first load module 40a, DC power output from the first main power source device 30a. The second power supply circuit 38b supplies, to a second load module 40b, the DC power output from the first main power source device 30a. The third power supply circuit 38c supplies, to a third load module 40c, DC power output from the second main power source device 30b. The fourth power supply circuit 38d supplies, to a fourth load module 40d, the DC power output from the second main power source device 30b.

Each of the first load module 40a, the second load module 40b, the third load module 40c, and the fourth load module 40d includes two VTOL drive devices 42 and one cruise drive device 44.

Each VTOL drive device 42 includes an inverter 46 and the VTOL electric motor 20. The inverter 46 converts the DC power input to the inverter 46 into three-phase AC power, and outputs the AC power to the VTOL electric motor 20.

Each cruise drive device 44 includes an inverter 48 and the cruise electric motor 24. The inverter 48 converts the DC power input to the inverter 48 into three-phase AC power, and outputs the AC power to the cruise electric motor 24.

Each of the first load module 40a and the third load module 40c includes a DC-DC converter 50. The DC-DC converter 50 steps down the voltage of the DC power input to the DC-DC converter 50, and outputs the DC power to a device operated by DC power. The device operated by DC power is, for example, a cooling device that cools the PDU 36, the inverters 46, the inverters 48, and the like.

The first load module 40a, the second load module 40b, the third load module 40c, and the fourth load module 40d may each include various sensors such as a voltage sensor and a current sensor, and elements such as a fuse, a relay, a breaker, a diode, a transistor, a resistor, a coil, and a capacitor.

A first auxiliary power source device 52a is connected to the first power supply circuit 38a. A second auxiliary power source device 52b is connected to the second power supply circuit 38b. A third auxiliary power source device 52c is connected to the third power supply circuit 38c. A fourth auxiliary power source device 52d is connected to the fourth power supply circuit 38d.

The first auxiliary power source device 52a, the second auxiliary power source device 52b, the third auxiliary power source device 52c, and the fourth auxiliary power source device 52d each include a battery 54. The battery 54 is, for example, a lithium ion battery.

The first auxiliary power source device 52a, the second auxiliary power source device 52b, the third auxiliary power source device 52c, and the fourth auxiliary power source device 52d may each include various sensors such as a voltage sensor and a current sensor, and elements such as a fuse, a relay, a breaker, a diode, a transistor, a resistor, a coil, and a capacitor.

The first power supply circuit 38a and the third power supply circuit 38c are connected by a first connection circuit 56a. The second power supply circuit 38b and the fourth power supply circuit 38d are connected by a second connection circuit 56b.

The power supply system 26 includes a main junction box 58 and a battery junction box 60.

The main junction box 58 includes a first disconnection device 62a and a second disconnection device 62b. The first disconnection device 62a can disconnect the first main power source device 30a from the first power supply circuit 38a and the second power supply circuit 38b. The second disconnection device 62b can disconnect the second main power source device 30b from the third power supply circuit 38c and the fourth power supply circuit 38d.

The main junction box 58 includes a third disconnection device 64a, a fourth disconnection device 64b, a fifth disconnection device 64c, and a sixth disconnection device 64d. The third disconnection device 64a can disconnect the first main power source device 30a from the first power supply circuit 38a. The fourth disconnection device 64b can disconnect the first main power source device 30a from the second power supply circuit 38b. The fifth disconnection device 64c can disconnect the second main power source device 30b from the third power supply circuit 38c. The sixth disconnection device 64d can disconnect the second main power source device 30b from the fourth power supply circuit 38d.

The main junction box 58 includes a first connection device 66a and a second connection device 66b. The first connection device 66a can connect the first power supply circuit 38a and the third power supply circuit 38c via the first connection circuit 56a. The second connection device 66b can connect the second power supply circuit 38b and the fourth power supply circuit 38d via the second connection circuit 56b.

The first disconnection device 62a, the second disconnection device 62b, the third disconnection device 64a, the fourth disconnection device 64b, the fifth disconnection device 64c, the sixth disconnection device 64d, the first connection device 66a, and the second connection device 66b each include two contactors 68. One contactor 68 is provided on the positive wire, and another contactor 68 is provided on the negative wire.

The main junction box 58 includes a first backflow prevention device 70a, a second backflow prevention device 70b, a third backflow prevention device 70c, and a fourth backflow prevention device 70d. The first backflow prevention device 70a, the second backflow prevention device 70b, the third backflow prevention device 70c, and the fourth backflow prevention device 70d each include a diode 72 and an insulated gate bipolar transistor (hereinafter, referred to as IGBT) 74. In a case where the IGBT 74 is OFF, the diode 72 prevents a backflow of the current in each of the first power supply circuit 38a, the second power supply circuit 38b, the third power supply circuit 38c, and the fourth power supply circuit 38d. In a case where the IGBT 74 is ON, by bypassing the diode 72, the backflow of the current is allowed in each of the first power supply circuit 38a, the second power supply circuit 38b, the third power supply circuit 38c, and the fourth power supply circuit 38d.

The battery junction box 60 includes a seventh disconnection device 78a, an eighth disconnection device 78b, a ninth disconnection device 78c, and a tenth disconnection device 78d. The seventh disconnection device 78a, the eighth disconnection device 78b, the ninth disconnection device 78c, and the tenth disconnection device 78d each include three contactors 80 and one precharge resistor 82. One contactor 80 of the three contactors 80 is provided on the positive wire. Another contactor 80 of the three contactors 80 is provided on the negative wire. Still another contactor 80 of the three contactors 80 is provided in a precharge circuit that bypasses the contactor 80 provided on the negative wire. The precharge resistor 82 is provided in series with the contactor 80 in the precharge circuit.

The seventh disconnection device 78a can disconnect the first auxiliary power source device 52a from the first power supply circuit 38a. The eighth disconnection device 78b can disconnect the second auxiliary power source device 52b from the second power supply circuit 38b. The ninth disconnection device 78c can disconnect the third auxiliary power source device 52c from the third power supply circuit 38c. The tenth disconnection device 78d can disconnect the fourth auxiliary power source device 52d from the fourth power supply circuit 38d.

In a case where the first main power source device 30a and the first load module 40a are precharged with the DC power of the first auxiliary power source device 52a, the seventh disconnection device 78a outputs the DC power from the first auxiliary power source device 52a to the first power supply circuit 38a via the precharge circuit. In a case where the first main power source device 30a and the second load module 40b are precharged with the DC power of the second auxiliary power source device 52b, the eighth disconnection device 78b outputs the DC power from the second auxiliary power source device 52b to the second power supply circuit 38b via the precharge circuit. In a case where the second main power source device 30b and the third load module 40c are precharged with the DC power of the third auxiliary power source device 52c, the ninth disconnection device 78c outputs the DC power from the third auxiliary power source device 52c to the third power supply circuit 38c via the precharge circuit. In a case where the second main power source device 30b and the fourth load module 40d are precharged with the DC power of the fourth auxiliary power source device 52d, the tenth disconnection device 78d outputs the DC power from the fourth auxiliary power source device 52d to the fourth power supply circuit 38d via the precharge circuit.

### [Configuration of Control System]

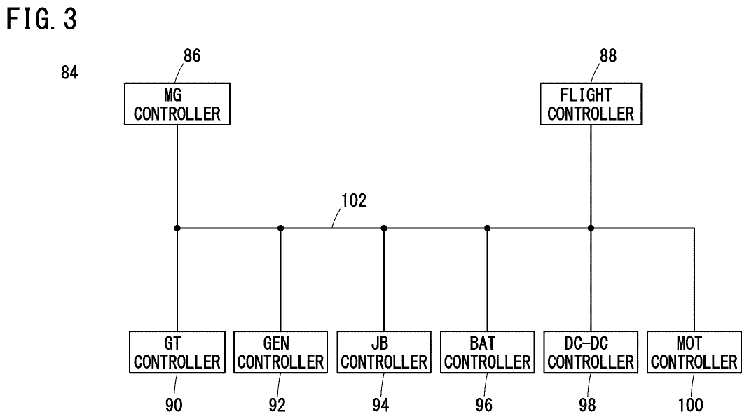

FIG. 3 is a schematic diagram showing a configuration of a control system according to the embodiment. A control system 84 according to the embodiment includes a management controller 86, a flight controller 88, a gas turbine controller 90, a generator controller 92, a junction box controller 94, a battery controller 96, a DC-DC controller 98, and a motor controller 100.

Each of the management controller 86, the flight controller 88, the gas turbine controller 90, the generator controller 92, the junction box controller 94, the battery controller 96, the DC-DC controller 98, and the motor controller 100 is connected to a bus 102. Each of the management controller 86, the flight controller 88, the gas turbine controller 90, the generator controller 92, the junction box controller 94, the battery controller 96, the DC-DC controller 98, and the motor controller 100 transmits and receives signals via control area network communication (hereinafter, referred to as CAN communication).

The management controller 86 manages the electric power supplied to each of the first load module 40a, the second load module 40b, the third load module 40c, and the fourth load module 40d. The flight controller 88 manages the operation of each of the first load module 40a, the second load module 40b, the third load module 40c, and the fourth load module 40d.

The gas turbine controller 90 controls the rotational speed and torque of the gas turbines 32 based on the information sent from the management controller 86. The gas turbine controller 90 monitors the state of the gas turbines 32 and sends information indicating the state of the gas turbines 32 to the management controller 86.

The generator controller 92 controls the rotational speed and torque of the generators 34 based on the information sent from the management controller 86. The generator controller 92 monitors the state of the generators 34 and the PDUs 36, and sends information indicating the state of the generators 34 and the PDUs 36 to the management controller 86.

The junction box controller 94 controls the main junction box 58 based on the information sent from the management controller 86. The junction box controller 94 controls the ON/OFF of each contactor 68 and the ON/OFF of each IGBT 74 in the main junction box 58. The junction box controller 94 monitors the state of the main junction box 58 and sends information indicating the state of the main junction box 58 to the management controller 86.

The battery controller 96 controls the battery junction box 60 based on the information sent from the management controller 86. The battery controller 96 controls the ON/OFF of each contactor 80 in the battery junction box 60. The battery controller 96 monitors the state of each battery 54 and the battery junction box 60, and sends information indicating the state of each battery 54 and the battery junction box 60 to the management controller 86. The battery controller 96 sends, to the management controller 86, information such as the state of charge (SOC) of the battery 54, the upper limit value of the output power of the battery 54, and the upper limit value of the input power of the battery 54, as the state of the battery 54. The battery controller 96 sends, to the management controller 86, information such as the ON/OFF state of each contactor 80 as the state of the battery junction box 60.

The DC-DC controller 98 controls the DC-DC converters 50 based on the information sent from the flight controller 88. The motor controller 100 controls the VTOL drive devices 42 and the cruise drive devices 44 based on the information sent from the flight controller 88.

In CAN communication, all data is transmitted in frames. There are four types of frames, namely, data frames, remote frames, error frames, and overload frames. Data is transmitted from one node (controller) to one or more nodes in a data frame among these four types of frames.

Hereinafter, information processing in the control system 84 will be described using a data frame transmitted from the management controller 86 to the junction box controller 94.

### [Configurations of Management Controller and Junction Box Controller]

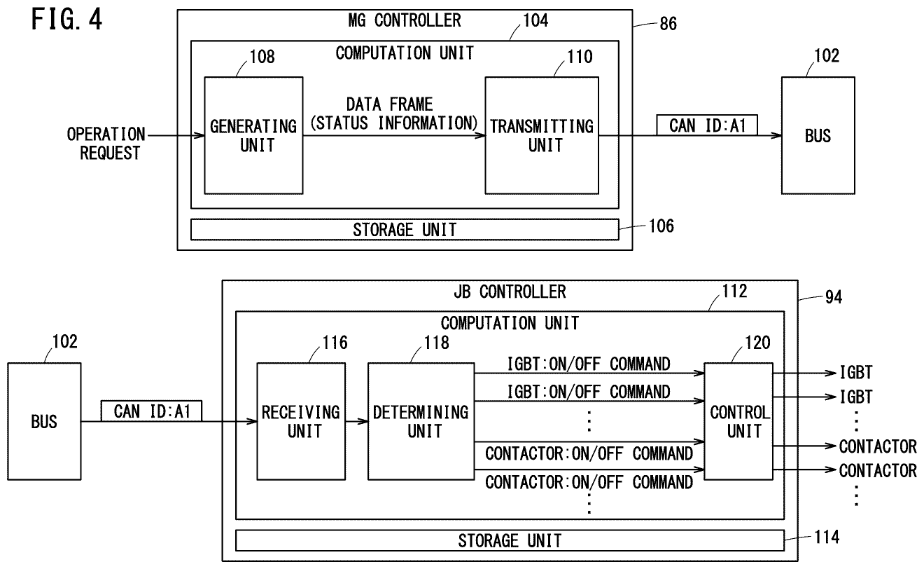

FIG. 4 shows control block diagrams of the management controller 86 and the junction box controller 94 according to the embodiment.

The management controller 86 includes a computation unit 104 and a storage unit 106. The computation unit 104 is, for example, a processor such as a central processing unit (CPU) or a graphics processing unit (GPU).

The computation unit 104 functions as a generating unit 108 and a transmitting unit 110. The generating unit 108 and the transmitting unit 110 are realized by the computation unit 104 executing programs stored in the storage unit 106.

At least part of the generating unit 108 and the transmitting unit 110 may be realized by an integrated circuit such as an application specific integrated circuit (ASIC) or a field-programmable gate array (FPGA). At least part of the generating unit 108 and the transmitting unit 110 may be realized by an electronic circuit including a discrete device.

The storage unit 106 is constituted by a volatile memory (not shown) and a non-volatile memory (not shown) which are computer-readable storage media. The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 106 may be included in the processor, the integrated circuit, or the like described above.

The generating unit 108 generates one data frame to be transmitted to the junction box controller 94 at a predetermined cycle. The data frame is formed of a plurality of fields. The plurality of fields include an identifier field, a data field, and the like. The generating unit 108 writes identifier information to the identifier field. The identifier information includes information indicating the junction box controller 94 as the destination of the data frame. The generating unit 108 writes status information to the data field. The status information will be described in detail later.

The transmitting unit 110 transmits the data frame generated by the generating unit 108 to the bus 102.

The junction box controller 94 includes a computation unit 112 and a storage unit 114. The computation unit 112 is, for example, a processor such as a CPU or a GPU.

The computation unit 112 functions as a receiving unit 116, a determining unit 118, and a control unit 120. The receiving unit 116, the determining unit 118, and the control unit 120 are realized by the computation unit 112 executing programs stored in the storage unit 114.

At least part of the receiving unit 116, the determining unit 118, and the control unit 120 may be realized by an integrated circuit such as an ASIC or an FPGA. At least part of the receiving unit 116, the determining unit 118, and the control unit 120 may be realized by an electronic circuit including a discrete device.

The storage unit 114 is constituted by a volatile memory (not shown) and a non-volatile memory (not shown) which are computer-readable storage media. The volatile memory is, for example, a RAM or the like. The non-volatile memory is, for example, a ROM, a flash memory, or the like. Data and the like are stored in, for example, the volatile memory. Programs, tables, maps, and the like are stored in, for example, the non-volatile memory. At least part of the storage unit 114 may be included in the processor, the integrated circuit, or the like described above.

The receiving unit 116 receives the data frame transmitted to the bus 102 by the management controller 86. The determining unit 118 determines ON/OFF commands for the respective IGBTs 74 and ON/OFF commands for the respective contactors 68 based on the status information written to the data field of the data frame received by the receiving unit 116.

The control unit 120 controls the IGBTs 74 based on the ON/OFF commands for the respective IGBTs 74 determined by the determining unit 118. Further, the control unit 120 controls the contactors 68 based on the ON/OFF commands for the respective contactors 68 determined by the determining unit 118.

### [Configuration of Data Field]

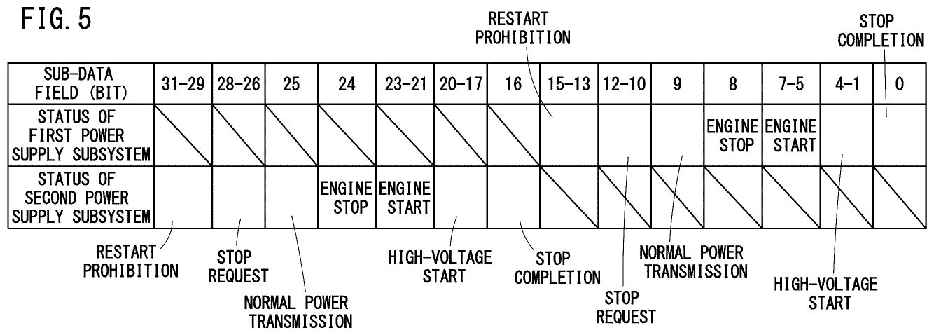

FIG. 5 is a diagram showing a configuration of the data field according to the embodiment. The data frame transmitted from the management controller 86 to the junction box controller 94 includes a data field having a data length of 4 bytes (32 bits). It should be noted that the data length of the data field is not limited to 4 bytes.

As described above, the status information is written to the data field by the generating unit 108 of the management controller 86. The status information is, for example, information indicating the status of the power supply system 26. The respective devices (the IGBTs 74 and the contactors 68) of the main junction box 58 are controlled according to the status of the power supply system 26. The status of the power supply system 26 includes, for example, an engine start status, an engine stop status, and the like. The engine start status indicates a state from when a start request for the gas turbine 32 is received to when the start of the gas turbine 32 is completed. The engine stop status indicates a state in which the gas turbine 32 is stopped.

The data field is divided into a plurality of sub-data fields. A sub-data field is allocated in advance to each piece of status information. For example, a sub-data field of 23rd to 21st bits is allocated to the information indicating the engine start status related to the second power supply subsystem 28b.

### [Allocation of Signals to Statuses]

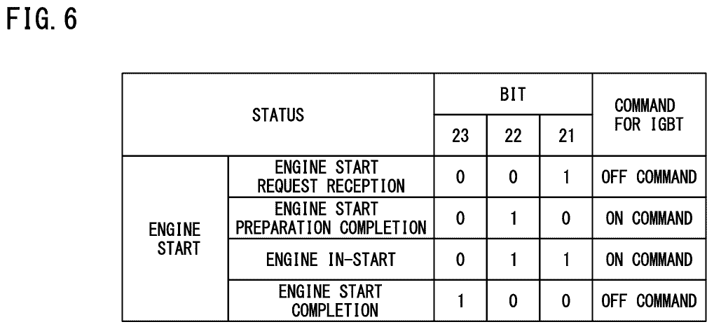

FIG. 6 is a diagram showing an example of allocation of signals to statuses.

The engine start status is further divided into an engine start request reception status, an engine start preparation completion status, an engine in-start status (engine status during starting), and an engine start completion status. FIG. 6 shows the correspondence relationship between each status of the engine start status of the second power supply subsystem 28b and each signal, and the correspondence relationship between each status and a command for each IGBT 74 of the second power supply subsystem 28b.

In a case where the management controller 86 receives an engine start request from an upper-level system (not shown), the generating unit 108 selects the engine start request reception status as the status. As shown in FIG. 6, a signal “001” of 23rd to 21st bits of the data field is allocated in advance to the engine start request reception status. The generating unit 108 generates a data frame in which the signal “001” is included in the 23rd to 21st bits of the data field.

In a case where the junction box controller 94 receives the data frame in which the 23rd to 21st bits of the data field are the signal “001”, the determining unit 118 determines OFF commands as the commands for the respective IGBTs 74 of the second power supply subsystem 28b.

As a result, in a case where the second power supply subsystem 28b is in the engine start request reception status, the IGBTs 74 of the second power supply subsystem 28b are controlled to be turned off.

Similarly, in a case where the generating unit 108 of the management controller 86 selects each of the engine start preparation completion status, the engine in-start status, and the engine start completion status, the generating unit 108 generates a data frame including a signal based on the correspondence relationship shown in FIG. 6. Further, the determining unit 118 of the junction box controller 94 determines commands for the respective IGBTs 74 of the second power supply subsystem 28b based on the correspondence relationship shown in FIG. 6.

### Comparative Example

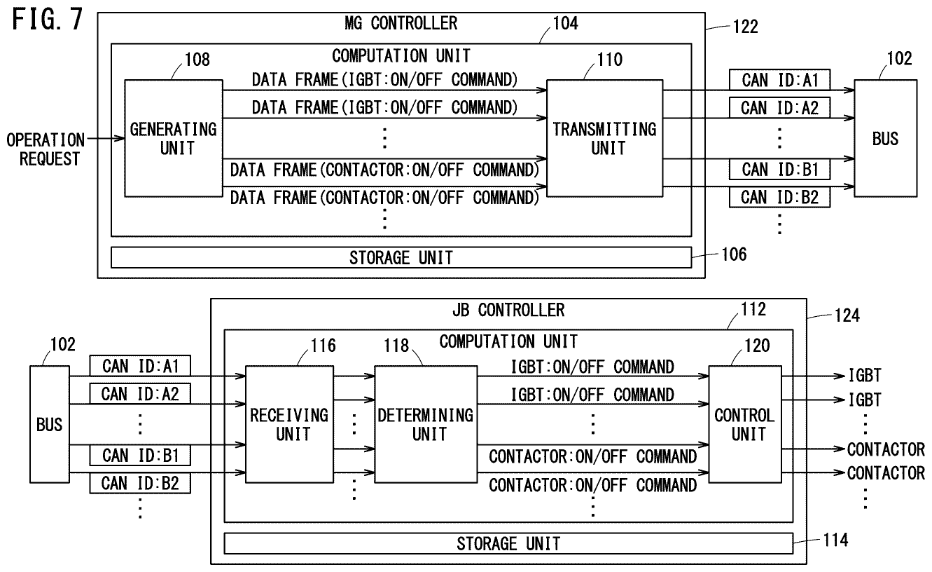

FIG. 7 shows control block diagrams of a management controller 122 and a junction box controller 124 according to a comparative example.

The configurations of the management controller 122 and the junction box controller 124 in the comparative example are the same as the configurations of the management controller 86 and the junction box controller 94 in the embodiment. However, the management controller 122 in the comparative example and the management controller 86 in the embodiment are different in the method of generating a data frame. Further, the junction box controller 124 in the comparative example and the junction box controller 94 in the embodiment are different in the method of determining commands for the respective IGBTs 74 and the respective contactors 68.

In the comparative example, the generating unit 108 of the management controller 122 generates a plurality of data frames to be transmitted to the junction box controller 124 at a predetermined cycle. One data frame is generated for one device (the contactor 68 or the IGBT 74) in the main junction box 58. For example, the main junction box 58 shown in FIG. 2 includes sixteen contactors 68 and four IGBTs 74, and therefore, twenty data frames are generated. The generating unit 108 writes command information for one device to the data field of each data frame.

In the comparative example, the determining unit 118 of the junction box controller 124 determines an ON/OFF command for each device based on the command information written to the data field of each data frame.

Therefore, in the comparative example, a large number of data frames are transmitted from the management controller 122 to the junction box controller 124 at a predetermined cycle, and thus the amount of traffic on the bus 102 increases. Normally, when the bus 102 is used by one node (controller), the other nodes cannot transmit data frames. Therefore, the communication speed is reduced due to an increase in the amount of traffic on the bus 102.

In contrast, in the embodiment, one data frame is transmitted from the management controller 86 to the junction box controller 94 at a predetermined cycle, and therefore, the amount of traffic on the bus 102 can be reduced. In addition, since the amount of traffic on the bus 102 is reduced, it is possible to suppress a decrease in the communication speed.

### [Data Frame Transmission Process]

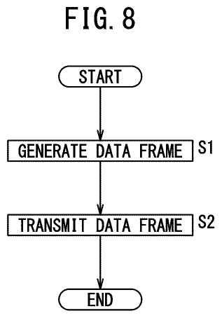

FIG. 8 is a flowchart of a data frame transmission process according to the embodiment. The data frame transmission process is executed at a predetermined cycle in the management controller 86.

In step S1, the generating unit 108 generates one data frame to be transmitted to the junction box controller 94. Status information is written to the data field of the data frame. Thereafter, the process proceeds to step S2.

In step S2, the transmitting unit 110 transmits the data frame to the bus 102. Thereafter, the data frame transmission process is ended.

### [Device Control Process]

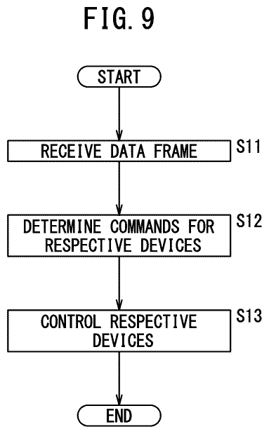

FIG. 9 is a flowchart of a device control process according to the embodiment. The device control process is executed at a predetermined cycle in the junction box controller 94.

In step S11, the receiving unit 116 receives the data frame transmitted to the bus 102 by the management controller 86. Thereafter, the process proceeds to step S12.

In step S12, the determining unit 118 determines commands for the respective devices based on the status information written to the data field of the data frame received by the receiving unit 116. Thereafter, the process proceeds to step S13.

In step S13, the control unit 120 controls the devices based on the commands for the respective devices determined by the determining unit 118. Thereafter, the device control process is ended.

The following supplementary notes are further disclosed in relation to the above-described embodiment.

### Supplementary Note 1

The control system (84) of the present disclosure is a control system in which signals are transmitted and received between a plurality of control devices via serial communication, wherein the first control device (86) of the plurality of control devices includes: the generating unit (108) configured to generate a data frame including a plurality of sub-data fields; and the transmitting unit (110) configured to transmit the data frame generated by the generating unit, and the second control device (94) of the plurality of control devices includes: the receiving unit (116) configured to receive the data frame transmitted from the first control device; the determining unit (118) configured to determine commands for a plurality of devices, respectively, based on the information written to the sub-data fields of the data frame received by the receiving unit; and the control unit (120) configured to control the devices based on the commands determined by the determining unit, and wherein the generating unit writes the status information, which is information indicating a status selected from a plurality of statuses, to the sub-data field allocated in advance to the status information, and the determining unit determines the commands for the respective devices based on the data frame received by the receiving unit. According to this feature, it is possible to reduce the amount of traffic caused by serial communication and suppress a decrease in the communication speed.

### Supplementary Note 2

In the control system according to Supplementary Note 1, the plurality of control devices may transmit and receive signals via control area network communication. According to this feature, it is possible to reduce the amount of traffic caused by serial communication and suppress a decrease in the communication speed.

### Supplementary Note 3

The moving object (10) of the present disclosure includes the control system according to Supplementary Note 1 or 2. According to this feature, it is possible to reduce the amount of traffic caused by serial communication and suppress a decrease in the communication speed.

### Supplementary Note 4

The information processing method of the control system of the present disclosure is an information processing method of a control system in which signals are transmitted and received between a plurality of control devices via serial communication, wherein the first control device of the plurality of control devices executes: the generating step in which the generating unit generates a data frame including a plurality of sub-data fields; and the transmitting step in which the transmitting unit transmits the data frame generated by the generating unit, and the second control device of the plurality of control devices executes: the receiving step in which the receiving unit receives the data frame transmitted from the first control device; the determining step in which the determining unit determines commands for a plurality of devices, respectively, based on the information written to the sub-data fields of the data frame received by the receiving unit; and the control step in which the control unit controls the devices based on the commands determined by the determining unit, and wherein, in the generating step, the status information, which is information indicating a status selected from a plurality of statuses, is written to the sub-data field allocated in advance to the status information, and in the determining step, the determining unit determines the commands for the respective devices based on the data frame received by the receiving unit. According to this feature, it is possible to reduce the amount of traffic caused by serial communication and suppress a decrease in the communication speed.

Although the present disclosure has been described in detail, the present disclosure is not limited to the above-described individual embodiments. Various additions, replacements, modifications, partial deletions, and the like can be made to these embodiments without departing from the gist of the present disclosure, or without departing from the essence of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A control system in which signals are transmitted and received between a plurality of control devices via serial communication,
wherein a first control device of the plurality of control devices comprises one or more processors that execute computer-executable instructions stored in a memory, and
the one or more processors execute the computer-executable instructions to cause the first control device to:
write status information, which is information indicating a status selected from a plurality of statuses, to a sub-data field allocated in advance to the status information, thereby generating a data frame including a plurality of the sub-data fields; and
transmit the data frame that has been generated, and
wherein a second control device of the plurality of control devices comprises one or more processors that execute computer-executable instructions stored in a memory, and
the one or more processors execute the computer-executable instructions to cause the second control device to:
receive the data frame transmitted from the first control device;
determine commands for a plurality of devices, respectively, based on information written to the sub-data fields of the data frame that has been received; and
control the devices based on the commands that have been determined.

2. The control system according to claim 1, wherein
the plurality of control devices transmit and receive the signals via control area network communication.

3. A moving object comprising the control system according to claim 1.

4. An information processing method of a control system in which signals are transmitted and received between a plurality of control devices via serial communication, the method comprising:
causing a first control device of the plurality of control devices to execute
generating a data frame including a plurality of sub-data fields, and
transmitting the data frame that has been generated; and
causing a second control device of the plurality of control devices to execute
receiving the data frame transmitted from the first control device,
determining commands for a plurality of devices, respectively, based on information written to the sub-data fields of the data frame that has been received, and
controlling the devices based on the commands that have been determined,
wherein, in the generating of the data frame, status information, which is information indicating a status selected from a plurality of statuses, is written to the sub-data field allocated in advance to the status information, and
in the determining of the commands, the commands for the respective devices are determined based on the data frame that has been received.
